(19) United States
(12) Patent Application Publication
(10) Pub. No.: US 2015/0169006 A1
(43) Pub. Date: Jun. 18, 2015

(54) FLEXIBLE DISPLAY DEVICE

(71) Applicant: Samsung Display Co., Ltd., Yongin-City (KR)

(72) Inventors: JONGHO CHONG, Hwaseong-si (KR); SEUNGBAE LEE, Seoul (KR); EUNJUNG LEE, Seongnam-si (KR); SUNGSU HONG, Seoul (KR)

(21) Appl. No.: 14/480,954

(22) Filed: Sep. 9, 2014

(30) Foreign Application Priority Data
Dec. 13, 2013 (KR) 10-2013-0155696

(51) Int. Cl. G06F 1/16; G06F 3/14; G09G 5/36; G09G 5/00; G09G 5/12

(52) U.S. Cl. CPC G06F 1/1652; G09G 5/003; G09G 5/12; G09G 5/363; G06F 3/1423; G06F 1/1643; G09G 2380/02; G09G 2320/08; G09G 2320/10

(57) ABSTRACT

A flexible display device includes a flexible display panel which operates based on an operation mode thereof, where the flexible display panel includes a display part, and a second display part connected to the first display part, wherein the second display part operates in a transmission mode to transmit a first image displayed in the first display part when the flexible display panel is in a bent shape in which the second display part is disposed to overlap the first display part, and the second display part operates in a display mode to display a second image when the flexible display panel is in an unbent shape, in which the second display part does not overlap the first display part.

This application claims priority to Korean Patent Application No. 10-2013-0155696, filed on Dec. 13, 2013, and all the benefits accruing therefrom under 35 U.S.C. §119, the content of which in its entirety is herein incorporated by reference.

### BACKGROUND

1. Field

The disclosure relates to a flexible display device. More particularly, the present disclosure relates to a flexible display device configured to display various images.

2. Description of the Related Art

Various display devices for displaying a multimedia image, such as a game device, a computer monitor, a mobile phone, a navigation device, a smart television, etc., have been developed.

In recent years, a display device (hereinafter, referred to as a flexible display device), which is curved or bent in consideration of user's need, has been developed. The flexible display device includes a flexible display panel and various functional members.

### SUMMARY

The disclosure provides a flexible display device capable of displaying different images depending on a shape thereof

Embodiments of the invention provide a flexible display device which operates based on an operation mode thereof, which is selected by a shape thereof, where the flexible display panel includes a first display part and a second display part connected to the first display part, where the second display part operates in a transmission mode to transmit a first image displayed in the first display part when the flexible display panel is in a bent shape in which the second display part is disposed to overlap the first display part, and the second display part operates in a display mode to display a second image when the flexible display panel is in an unbent shape, in which the second display part does not overlap the first display part.

In an exemplary embodiment, the first display part may display a third image different from the second image when the flexible display panel is in the unbent shape.

In an exemplary embodiment, the second image and the third image may provide information independent of each other.

In an exemplary embodiment, the second image and the third image may correspond to different portions of a single image.

In an exemplary embodiment, the flexible display panel may further include a third display part connected to the first display part, where the third display part may operate in the transmission mode to transmit the first image when the flexible display panel is in the bent shape, in which the third display part is disposed to overlap the first display part, and the third display part may operate in the display mode to display a third image when the flexible display panel is in the unbent shape in which the third display part does not overlap the first display part.

In an exemplary embodiment, the flexible display device may further include a sensor which senses deformation in the shape of the flexible display panel.

In an exemplary embodiment, the sensor may include a stress sensor disposed in a boundary between the first display part and the second display part.

In an exemplary embodiment, the sensor may include a gravity sensor disposed in the second display part.

In an exemplary embodiment, the flexible display device may further include a first touch panel disposed on a lower surface of the flexible display panel, and a second touch panel disposed on an upper surface of the flexible display panel.

In an exemplary embodiment, the first touch panel may be disposed to overlap the second display part, and the second touch panel may be disposed to overlap at least the first display part of the first and second display parts.

In an exemplary embodiment, the first display part may include a plurality of first pixels respectively disposed in first pixel areas among pixel areas.

In an exemplary embodiment, the second display part may include a plurality of second pixels respectively disposed in second pixel areas among the pixel areas.

In an exemplary embodiment, each of the second pixel areas may include a transmission area and a display area.

In an exemplary embodiment, the first display device disposed in the first pixel area may include an organic light emitting diode, and the organic light emitting diode may include an electrode having a same area as an area of a corresponding first pixel area of the first pixel areas.

In an exemplary embodiment, the second display device disposed in the second pixel area may include an organic light emitting diode, and the organic light emitting diode may include an electrode which overlaps the display area and exposes the transmission area.

According to exemplary embodiments, the flexible display device displays the image corresponding to the operation mode selected by the shape of the flexible display panel. The second display part operates in the transmission mode or the display mode in accordance with the position of the second display part with respect to the first display part.

In such embodiments, the display device displays the image generated by the first display part and passing through the second display part when the first and second display parts are in the bent shape. The display device, which is in the bent shape, provides the image information corresponding to the user's needs and the portability of the display device is improved.

In such embodiments, when the first and second display parts are in the unbent shape, the display device displays the image larger than the image displayed when the display device is in the bent shape and thereby provides various image information.

### BRIEF DESCRIPTION OF THE DRAWINGS

The above and other features of exemplary embodiments of the invention will become readily apparent by reference to the following detailed description when considered in conjunction with the accompanying drawings, in which:

FIG. 1A is a perspective view showing an exemplary embodiment of a flexible display device that is bent, according to the invention;

FIG. 1B is a perspective view showing an exemplary embodiment of a flexible display device that is stretched out, according to the invention;

FIG. 1C is a block diagram showing an exemplary embodiment of a flexible display device, according to the invention;

FIG. 2 is a plan view showing an exemplary embodiment of a display panel according to the invention;

FIG. 3 is an equivalent circuit diagram showing a pixel of an exemplary embodiment of a display panel, according to the invention;

FIG. 4A is a plan view showing a pixel area of a first display part of an exemplary embodiment of a display panel according to the invention;

FIG. 4B is a plan view showing a pixel area of a second display part of an exemplary embodiment of a display panel according to the invention;

FIG. 5A is a cross-sectional view showing a pixel area of a first display part of an exemplary embodiment of a display panel according to the invention;

FIG. 5B is a cross-sectional view showing a pixel area of a second display part of an exemplary embodiment of a display panel according to the invention;

FIG. 6A is a plan view showing an image displayed on an exemplary embodiment of a display panel during a first mode, according to the invention;

FIG. 6B is a side view showing an exemplary embodiment of a display panel operating in the first mode;

FIG. 7A is a plan view showing an image displayed on an exemplary embodiment of a display panel during a second mode, according to the invention;

FIG. 7B is a side view showing an exemplary embodiment of a display panel operating in the second mode;

FIG. 8A is a side view showing an alternative exemplary embodiment of a flexible display panel in a bent shape, according to the invention; and

FIG. 8B is a side view showing an alternative exemplary embodiment of a flexible display panel in an unbent shape, according to the invention.

### DETAILED DESCRIPTION

The invention will be described more fully hereinafter with reference to the accompanying drawings, in which various embodiments are shown. The invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings.

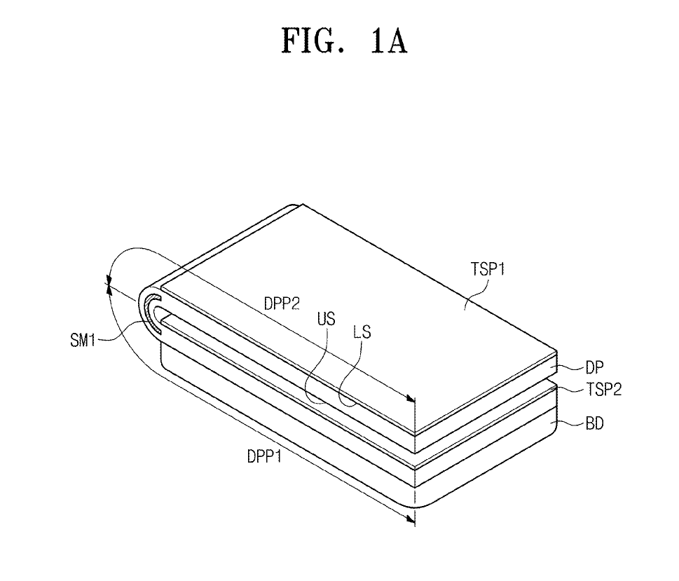

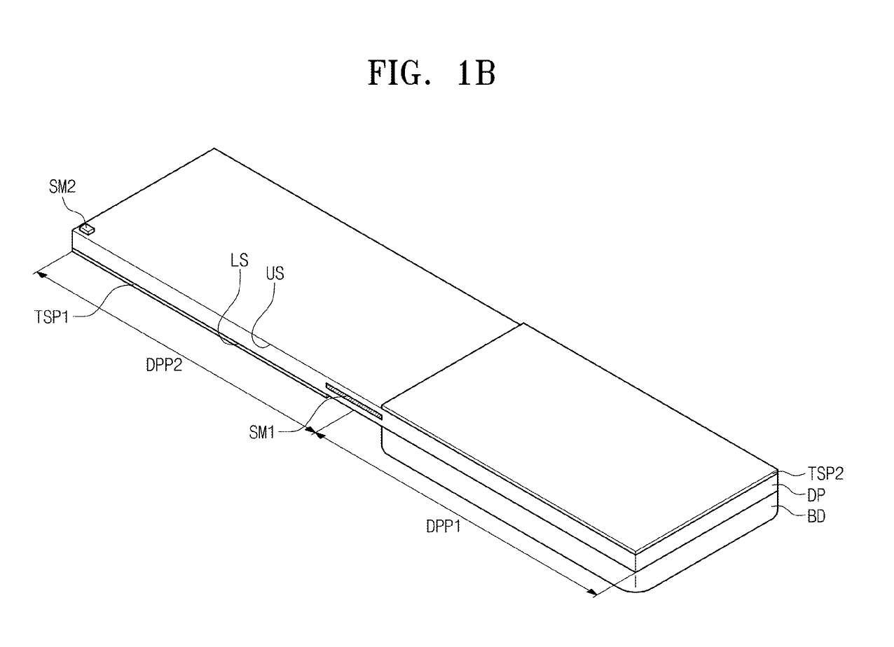

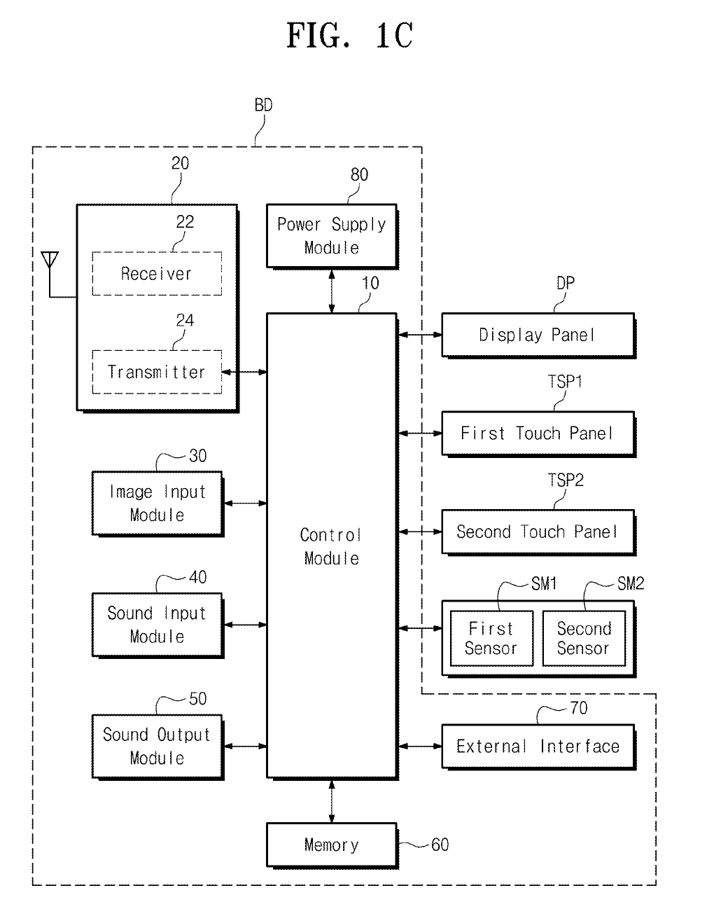

FIG. 1A is a perspective view showing an exemplary embodiment of a flexible display device that is bent, according to the invention, FIG. 1B is a perspective view showing an exemplary embodiment of a flexible display device that is stretched out, according to the invention, and FIG. 1C is a block diagram showing an exemplary embodiment of a flexible display device according to the invention.

Referring to FIGS. 1A and 1B, an exemplary embodiment of the flexible display device (hereinafter, referred to as “display device”) includes a flexible display panel DP (hereinafter, referred to as “display panel”), a first touch panel TSP1, a second touch panel TSP2, sensors SM1 and SM2, and a body part BD.

The display panel DP includes a first display part DPP1 and a second display part DPP2. The display panel DP may be a single unitary and indivisible flexible display panel. The display panel DP is configured to be bent at a boundary area between the first display part DPP1 and the second display part DPP2. In an exemplary embodiment, the display panel DP may be bent with reference to a boundary line between the first display part DPP1 and the second display part DPP2. Each of the first display part DPP1 and the second display part DPP2 may include a bending area adjacent to the boundary line.

The display panel DP operates in an operation mode selected or determined based on a shape thereof. Different portions of the display panel DP may be activated based on the selected operation mode. An image is displayed in the activated portions of the display panel DP. In an exemplary embodiment, when the display panel DP in a bent shape, which is bent or folded as shown in FIG. 1A, the display panel DP may operate in a first mode, and when the display panel DP in an unbent shape, which is stretched out, flat, planar or unfolded as shown in FIG. 1B, the display panel DP may operate in a second mode.

When the display panel DP is in the bent shape, the second display part DPP2 is disposed to overlap the first display part DPP1. When the display panel DP is in the bent shape, the first display part DPP1 operates in a display mode and the second display part DPP2 operates in a transmission mode.

In an exemplary embodiment, when the display panel DP is in the bent shape, the first display part DPP1 is activated to display the image and the second display part DPP2 is deactivated, and thus the second display part DPP2 does not display the image. The second display part DPP2 transmits the image displayed on the first display part DPP1 therethrough. The first display part DPP1 and the second display part DPP2, which overlap each other, form a first display surface. The first display surface is an imaginary surface defined on the front surface of the display panel DP in the bent shape.

When the display panel DP is stretched out, that is, in the unbent shape, both the first and second display parts DPP1 and DPP2 operate in the display mode. The clause of “the display panel DP is in the unbent shape” used herein means that the display panel DP has a shape in which the first display part DPP1 disposed not to overlap the second display part

DPP2. When the display panel DP is in the unbent shape, each of the first and second display parts DPP1 and DPP2 is activated to display an image. When the display panel DP is in the unbent shape, the first and second display parts DPP1 and DPP2 form a second display surface. The second display surface is an imaginary surface defined on the front surface of the display panel DP in the unbent shape. The second display surface may have an area greater than an area of the first display surface. The first and second display surfaces will be described later in greater detail.

The first touch panel TSP1 and the second touch panel TSP2 calculate coordinate information of touch positions of external inputs, e.g., a stylus pen, a finger of a user, etc. The first and second touch panels TSP1 and TSP2 output touch signals including the coordinate information. Each of the first and second touch panels TSP1 and TSP2 may be a resistive type touch panel, an electrostatic capacitive type touch panel, or an electromagnetic induction type touch panel, for example.

The first touch panel TSP1 is disposed on a lower surface LS of the display panel DP. The first touch panel TSP1 overlaps the second display part DPP2. When the display panel DP is in the bent shape, the first touch panel TSP1 is disposed on the first display surface. Accordingly, the first touch panel TSP1 is disposed on the first display surface of the display device when the display panel DP is in the bent shape. The first touch panel TSP1 is activated when the display panel DP operates in the first mode.

The second touch panel TSP2 is disposed on an upper surface US of the display panel DP. The second touch panel TSP2 overlaps at least the first display part DPP1 of the first and second display parts DPP1 and DPP2. In an alternative exemplary embodiment, the second touch panel TSP2 may be disposed to overlap both of the first and second display parts DPP1 and DPP2.

When the display panel DP is in the unbent shape, the second touch panel TSP2 is disposed on the second display surface. The second touch panel TSP2 is activated when the display panel DP operates in the second mode.

In an alternative exemplary embodiment, at least one of the first touch panel TSP1 and the second touch panel TSP2 may be omitted. In such an embodiment, the first and second touch panels TSP1 and TSP2 may be replaced with a keypad button on a hardware keyboard.

The sensors SM1 and SM2 sense deformation in the shape of the display panel DP, that is, a change of the shape of the display panel DP from the bent shape to the unbent shape or vice versa. The sensors SM1 and SM2 output a shape deformation signal when they sense the deformation in shape of the display panel DP. The shape deformation signal includes shape information of the display panel DP. The operation mode of the display panel DP is changed based on the shape deformation signal. The sensors SM1 and SM2 may include a stress sensor SM1 and a gravity sensor SM2.

The stress sensor SM1 is disposed to overlap the boundary area between the first display part DPP1 and the second display part DPP2. The stress sensor SM1 senses stress generated when the display panel DP is bent such that the shape of the display panel DO is sensed.

The stress sensor SM1 may include a silicon pattern. The silicon pattern has a resistance value that is changed when the stress is applied thereto due to a piezoresistance effect of the silicon. When a compression stress is applied to a p-type silicon pattern, the resistance is decreased, and when a tensile stress is applied to the p-type silicon pattern, the resistance is increased. When the compression stress is applied to an n-type silicon pattern, the resistance is increased, and when the tensile stress is applied to the n-type silicon pattern, the resistance is decreased. When the variation in resistance of the silicon pattern is sensed, the stress sensor SM1 determines that the display panel DP is in the bending state. The stress sensor SM1 may generate the shape deformation signal based on the resistance value of the silicon pattern.

In an exemplary embodiment, as shown in FIGS. 1A and 1B, the stress sensor SM1 may be disposed inside the display panel DP. In an alternative exemplary embodiment, the stress sensor SM1 may be disposed on a surface of the display panel DP.

The gravity sensor SM2 is disposed on the upper surface US of the display panel DP corresponding to the second display part DPP2. The gravity sensor SM2 senses variation in acceleration, which is caused when the second display part DPP2 is bent or stretched out. In an alternative exemplary embodiment, the gravity sensor SM2 may be disposed inside the second display part DPP2. The gravity sensor SM2 generates the shape deformation signal based on sensed acceleration value.

In an alternative exemplary embodiment, at least one of the stress sensor SM1 and the gravity sensor SM2 may be omitted. In an exemplary embodiment, the sensors may further include a gyro sensor to sense rotational inertia.

The body part BD is coupled to the lower surface LS of the display panel DP corresponding to the first display part DPP1. The body part BD includes a frame formed of a plastic or metal material, and a plurality of electronic modules disposed in the frame. The electronic modules control the operation of the display device. The electronic modules may be variously configured based on the use of the display device.

FIG. 1C shows the electronic modules included in the body part BD when the display device functions as a smart watch. Hereinafter, an exemplary embodiment of a method of operation of the display device will be described in detail with reference to FIG. 1C.

In an exemplary embodiment, the body part BD includes a control module 10, a wireless communication module 20, an image input module 30, a sound input module 40, a sound output module 50, a memory 60, an external interface 70, and a power supply module 80. In an exemplary embodiment, the modules of the body part BD may be mounted on a circuit board or electrically connected to each other through a flexible circuit board.

The control module 10 controls the whole operation of the smart watch. In one exemplary embodiment, for example, the control module 10 activates or deactivates the display panel DP, the first touch panel TSP1 and the second touch panel TSP2.

The control module 10 controls the display panel DP, the image input module 30, the sound input module 40 and the sound output module 50, based on the touch signal provided from the first and second touch panels TSP1 and TSP2. The control module 10 controls the display panel DP, the sound input module 40 and the sound output module 50 in response to the shape deformation signal provided from the sensors SM1 and SM2.

In an exemplary embodiment, the control module 10 selects the operation mode of the display panel DP in response to a mode change signal input by the user through the first and second touch panels TSP1 and TSP2. In such an embodiment, the control module 10 selects the operation mode of the display panel DP in response to the shape deformation signal provided from the sensors SM1 and SM2. The control module 10 provides image data to the display panel DP such that the image corresponding to the operation mode of the display device is displayed.

The wireless communication module 20 may transmit or receive a wireless signal with other terminals through a Bluetooth or Wi-Fi connection. The wireless communication module 20 may transmit or receive a sound signal through a conventional communication network. The wireless communication module 20 includes a transmitter 24 that modulates a signal to be transmitted, and a receiver 22 that demodulates the signal applied thereto.

The image input module 30 processes the image signal to convert the image signal to image data appropriate to be displayed on the display panel DP. The sound input module 40 receives an external sound signal through a microphone in a recording mode or a sound recognition mode, and converts the sound signal to electrical sound data. The sound output module 50 converts the sound data from the wireless communication module 20 or the sound data stored in the memory 60 and outputs the converted sound data.

The external interface 70 serves as an interface connected to an external charger, a wire/wireless data port and a card socket, e.g., a memory card, a subscriber identification module (“SIM”)/user identification module (“UIM”) card, etc. The power supply module 80 supplies a voltage to be used to drive the smart watch.

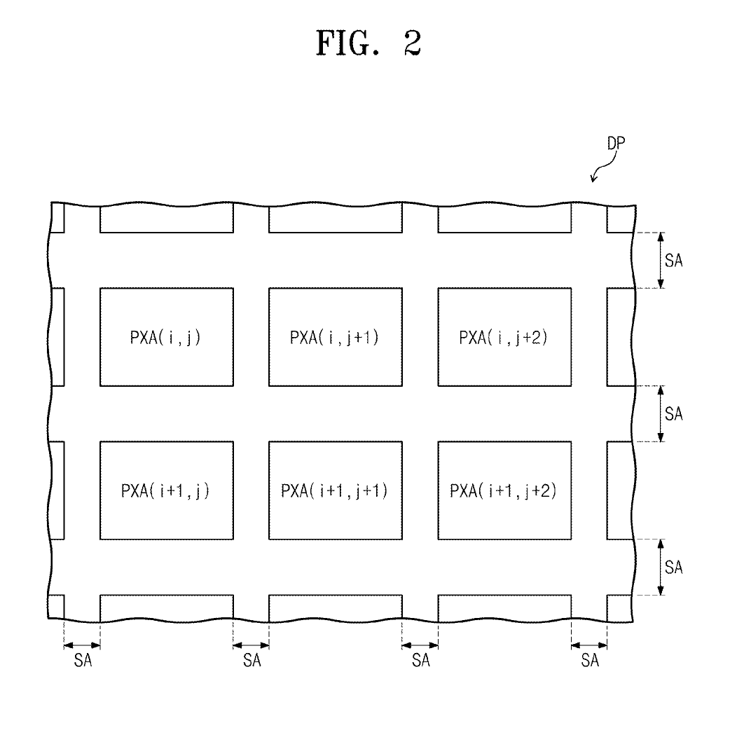

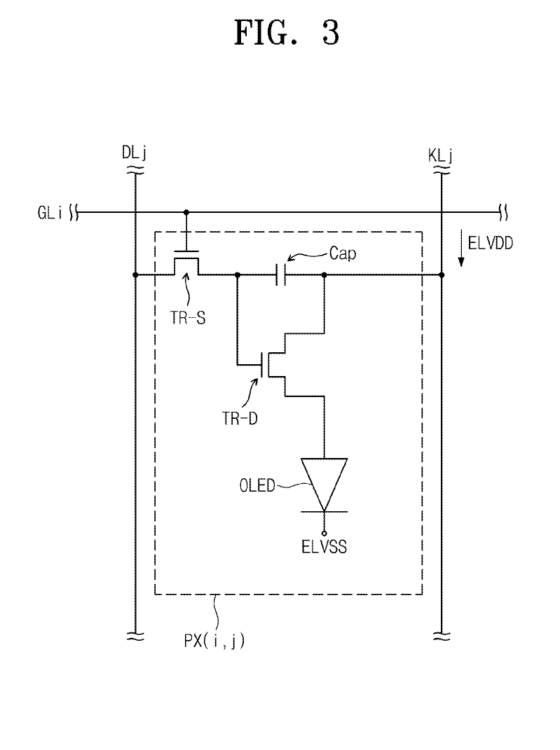

FIG. 2 is a plan view showing an exemplary embodiment of a display panel according to the invention, and FIG. 3 is an equivalent circuit diagram showing a pixel of an exemplary embodiment of a display panel according to the invention. Hereinafter, an exemplary embodiment of the display panel will be described in detail with reference to FIGS. 2 and 3.

The display panel DP may be an organic light emitting display panel, an electrophoretic display panel, or an electrowetting display panel. Hereinafter, an exemplary embodiment, where the display panel DP is the organic light emitting display panel, will be described. The organic light emitting display panel DP includes a flexible base substrate (not show, hereinafter, referred to as a “base substrate”), signal lines (not shown) disposed on the base substrate, insulating layers (not shown) disposed on the base substrate, and pixels (not shown) electrically connected to the signal lines.

Referring to FIG. 2, a plurality of pixel areas PXA(i, j) to PXA(i+1, j+2) and a peripheral area SA surrounding the pixel areas PXA(i, j) to PXA(i+1, j+2) are defined on the organic light emitting display panel DP. In an exemplary embodiment, the pixel areas may include six pixel areas PXA(i, j) to PXA(i+1, j+2) as shown in FIG. 2, but not being limited thereto. In such an embodiment, pixels are respectively disposed in the pixel areas PXA(i, j) to PXA(i+1, j+2) and the signal lines are disposed in the peripheral area SA.

FIG. 3 shows the equivalent circuit diagram of an exemplary embodiment of the pixel PX(i, j), but the configuration of the pixel PX(i, j) of an exemplary embodiment of a display panel DP is not be limited thereto or thereby. The pixel PX(i, j) receives a gate signal from an i-th gate line GLi and a data signal from a j-th data line DLj. The pixel PX(i, j) receives a first source voltage ELVDD from a j-th power supply line KLj.

The pixel PX(i, j) includes an organic light emitting diode OLED connected to a second source voltage ELVSS. The pixel PX(i, j) includes a switching thin film transistor TR-S, a driving thin film transistor TR-D, and a capacitor Cap as a circuit part configured to drive the organic light emitting diode OLED.

The switching thin film transistor TR-S outputs the data signal applied to the j-th data line DLj in response to the gate signal applied to the i-th gate line GLi. The capacitor Cap is charged with a voltage corresponding to the data signal provided from the switching thin film transistor TR-S.

The driving thin film transistor TR-D is connected to the organic light emitting diode OLED. The driving thin film transistor TR-D controls a driving current flowing through the organic light emitting diode OLED in accordance with an amount of electric charges charged in the capacitor Cap. The organic light emitting diode OLED emits the light during the turn-on period of the driving thin film transistor TR-D.

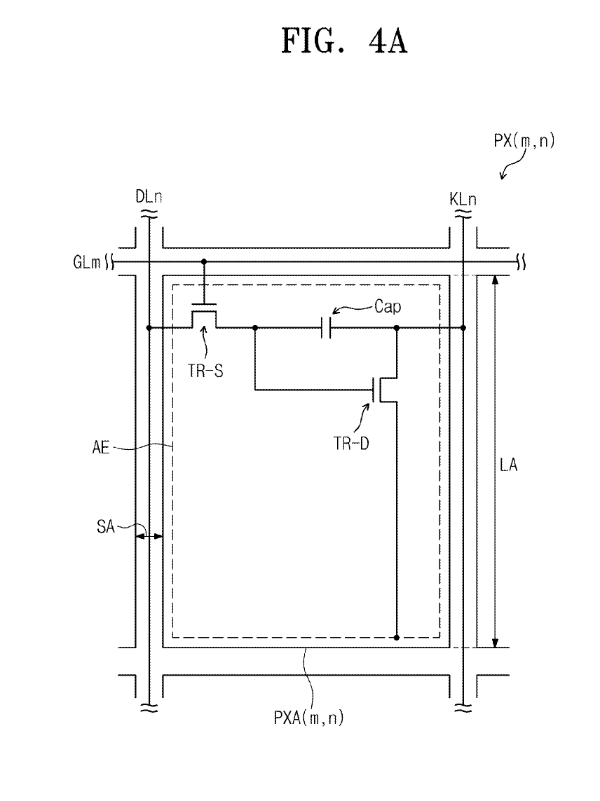

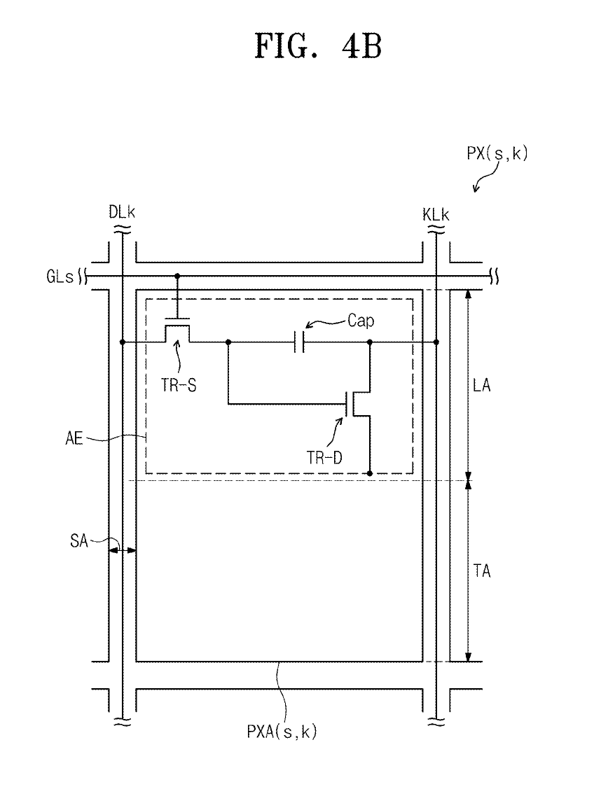

FIG. 4A is a plan view showing the pixel area of the first display part of an exemplary embodiment of the display panel according to the invention, and FIG. 4B is a plan view showing the pixel area of the second display part of an exemplary embodiment of the display panel according to the invention.

Referring to FIGS. 4A and 4B, a first pixel PX(m, n) is disposed in a first pixel area PXA(m, n) of the first display part DPP1 (refer to FIG. 1C), and a second pixel PX(s, k) is disposed in a second pixel area PXA(s, k) of the second display part DPP2 (refer to FIG. 1C). Each of the first pixel PX(m, n) and the second pixel PX(s, k) has the equivalent circuit diagram shown in FIG. 3.

The first pixel area PXA(m, n) includes a display area LA, and the second pixel area PXA(s, k) includes the display area LA and a transmission area TA. The display area LA corresponds to a light emitting area, and a first electrode AE of the organic light emitting diode OLED is disposed in the display area LA. The transmission area TA of the second pixel area PXA(s, k) is an area in which the first electrode AE of the organic light emitting diode OLED is not disposed.

The switching thin film transistor TR-S, the driving thin film transistor TR-D and the capacitor Cap of each of the first pixel PX(m, n) and the second pixel PX(s, k) are disposed to overlap the display area LA.

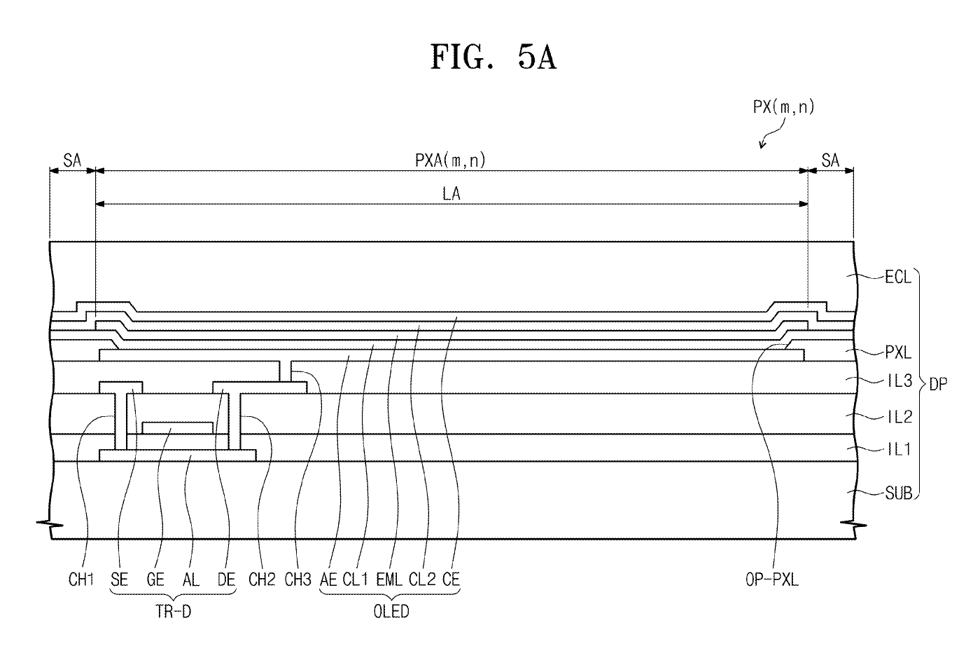

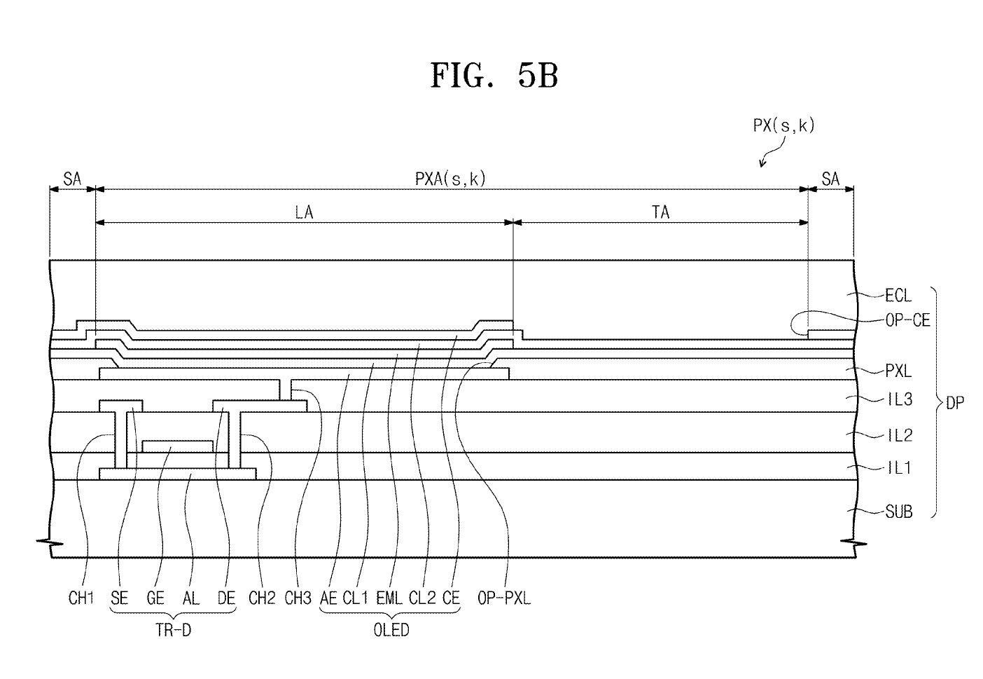

FIG. 5A is a cross-sectional view showing a pixel area of a first display part of an exemplary embodiment of a display panel according to the invention, and FIG. 5B is a cross-sectional view showing a pixel area of a second display part of an exemplary embodiment of a display panel according to the invention. Hereinafter, the first pixel PX(m, n) and the second pixel PX(s, k) will be described in greater detail with reference to FIGS. 5A and 5B.

Referring to FIGS. 5A and 5B, insulating layers IL1, IL2 and IL3, the driving thin film transistor TR-D and the organic light emitting diode OLED are disposed on the base substrate SUB. In an exemplary embodiment, the base substrate SUB may be a transparent substrate, and the base substrate SUB may include a material with high light transmittance. In such an embodiment, a buffer layer (not shown) may be disposed on a surface of the base substrate SUB to improve adhesive force between a lowermost insulating layer of the insulating layers and the base substrate SUB.

A semiconductor pattern AL of the driving thin film transistor TR-D is disposed on the base substrate SUB. A first insulating layer IL1 is disposed on the base substrate SUB to cover the semiconductor pattern AL. The first insulating layer IL1 includes an organic and/or inorganic layer. The first insulating layer IL1 includes a plurality of thin film layers. The first insulating layer IL1 includes a material with high light transmittance.

A control electrode GE of the driving thin film transistor TR-D is disposed on the first insulating layer IL1. A second insulating layer IL2 is disposed on the first insulating layer IL1 to cover the gate electrode GE. The second insulating layer IL2 includes an organic and/or inorganic layer. The second insulating layer IL2 includes a plurality of thin film layers. The second insulating layer IL2 includes a material with high light transmittance.

An input electrode SE and an output electrode DE of the driving thin film transistor TR-D are disposed on the second insulating layer IL2. The input electrode SE and the output electrode DE are connected to the semiconductor pattern AL respectively through a first contact hole CH1 and a second contact hole CH2, which are defined or formed through the first and second insulating layers IL1 and IL2. In such an embodiment, the driving thin film transistor TR-D may have a bottom gate structure.

A third insulating layer IL3 is disposed on the second insulating layer IL2 to cover the input electrode SE and the output electrode DE. The third insulating layer IL3 includes an organic and/or inorganic layer. The third insulating layer IL3 includes a plurality of thin film layers. The third insulating layer IL3 includes a material having high light transmittance.

A pixel definition layer PXL and the organic light emitting diode OLED are disposed on the third insulating layer IL3. The organic light emitting diode OLED includes the first electrode AE (hereinafter, referred to as “anode”), a first common layer CL1, an organic light emitting layer EML, a second common layer CL2, and a second electrode CE (hereinafter, referred to as “cathode”), which are sequentially stacked one on another. An opening OP-PXL is defined or formed through the pixel definition layer PXL to expose at least the anode AE. The pixel definition layer PXL includes a material with high light transmittance. The anode AE is disposed on the third insulating layer IL3. The anode AE is connected to the output electrode DE through a third contact hole CH3 defined or formed through the third insulating layer IL3. The anode AE may have a multi-layer structure including a reflective layer. In an exemplary embodiment, as described above, the organic light emitting diode OLED may be a top emission type organic light emitting diode OLED. The anode AE of the first pixel PX(m, n) is disposed in the display area LA of the first pixel area PXA(m, n). The anode AE of the first pixel PX(m, n) has substantially the same area as the display area LA of the first pixel area PXA(m,n).

The anode AE of the second pixel PX(s, k) is disposed in the display area LA of the second pixel area PXA(s, k) and not disposed in the transmission area TA. The anode AE of the second pixel PX(s, k) is disposed in a portion of the second pixel area PXA(s, k).

The first common layer CL1 is disposed on the anode AE. The first common layer CL1 may be disposed not only in the first pixel area PXA(m, n) and the second pixel area PXA(s, k), but also in the peripheral area SA. The first common layer CL1 includes a hole injection layer. The first common layer CL1 may further include a hole transport layer. The first common layer CL1 includes a material with high light transmittance.

The organic light emitting layer EML is disposed on the first common layer CL1. The organic light emitting layer EML of the first pixel PX(m, n) may have substantially the same shape as the anode AE of the first pixel PX(m, n) when viewed in a plan view. The organic light emitting layer EML of the second pixel PX(s, k) may have substantially the same shape as the anode AE of the second pixel PX(s, k) when viewed in a plan view.

The second common layer CL2 is disposed on the organic light emitting layer EML. The second common layer CL2 includes an electron injection layer. The second common layer CL2 further includes an electron transport layer. The cathode CE is disposed on the second common layer CL2. The cathode CE is disposed not only in the first pixel area PXA(m, n) and the second pixel area PXA(s, k), but also in the peripheral area SA.

In an exemplary embodiment, the cathode CE may not be disposed in the transmission area TA of the second pixel area PXA(s, k) such that the transmittance of the second display part DPP2 (refer to FIG. 1B) in the transmission mode is substantially improved. In an exemplary embodiment, an opening OP-CE is defined through the cathode CE in an area corresponding to the transmission area TA of the second pixel area PXA(s, k).

In an exemplary embodiment of the display panel DP, an opening may be defined in an area corresponding to the opening OP-CE of the cathode CE through at least one of the insulating layers IL1, IL2 and IL3, the pixel definition layer PXL, the first common layer CL1 and the second common layer CL2 to improve the light transmittance of the second display part DPP2 (refer to FIG. 1B) in the transmission mode. In such an embodiment the first common layer CL1, the second common layer CL2 and the cathode CE may include a material having high light transmittance.

A sealing layer ECL is disposed on the cathode CE. The sealing layer ECL may be disposed not only in the first and second pixel areas PXA(m, n) and PXA(s, k) but also in the peripheral area SA. The sealing layer ECL includes an organic and/or inorganic layer. In an exemplary embodiment, a fourth insulating layer may be further disposed between the cathode CE and the sealing layer ECL to planarize an upper portion of the cathode CE. In an alternative exemplary embodiment, the sealing layer ECL may be replaced with a sealing substrate.

Although not shown in the figures, in an exemplary embodiment, the switching thin film transistor TR-S may have the same structure as the driving thin film transistor TR-D. In an alternative exemplary embodiment, two electrodes of the capacitor Cap may be disposed on different layers of the first, second and third insulating layers IL1, IL2 and IL3.

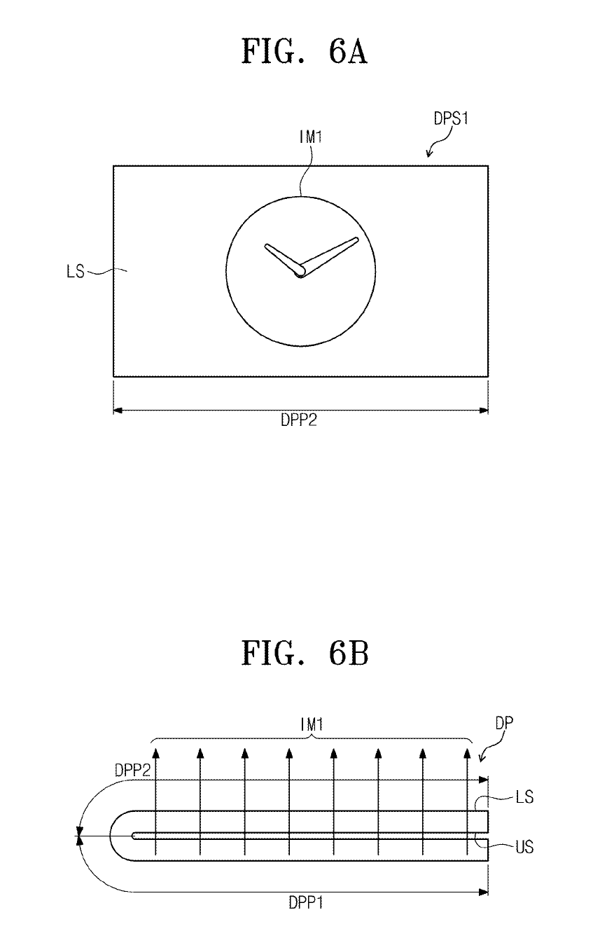

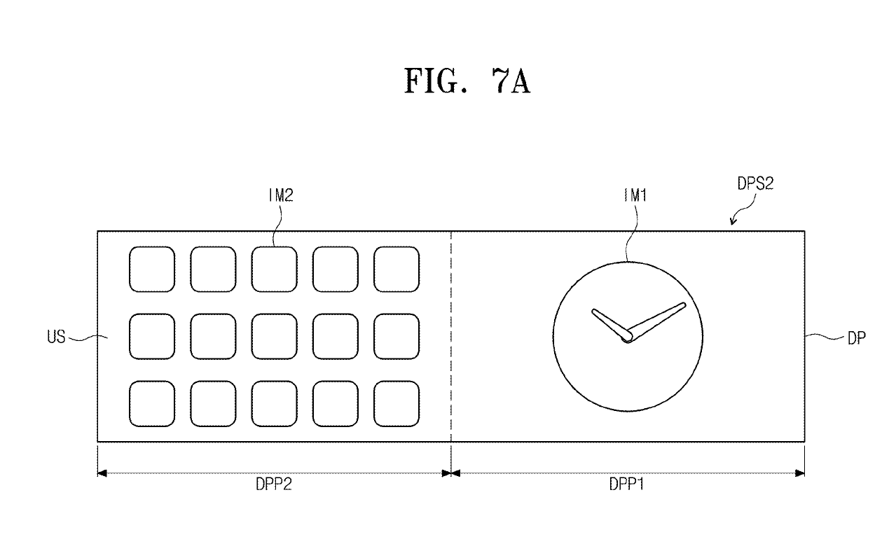

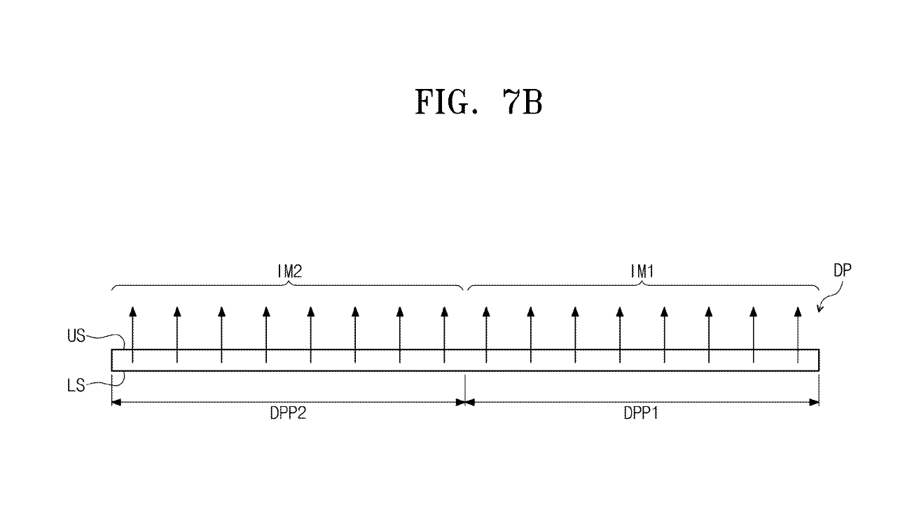

FIG. 6A is a plan view showing an image displayed on an exemplary embodiment of the display panel during the first mode, according to the invention, and FIG. 6B is a side view showing an exemplary embodiment of the display panel operating in the first mode. FIG. 7A is a plan view showing an image displayed on an exemplary embodiment of the display panel during the second mode, according to the invention and FIG. 7B is a side view showing an exemplary embodiment of the display panel operating in the second mode.

Referring to FIGS. 6A and 6B, when the display panel is in the first mode, the first display surface DPS1 is defined on the lower surface LS of the display panel DP corresponding to the second display part DPP2. A first image IM1 may be displayed on the first display surface DPS1. In FIG. 6A, an image of watch has been shown as the first image IM1.

The first image IM1 is generated by the first display part DPP1. The first image IM1 is displayed to the user after passing through the second display part DPP2 from the first display part DPP1. The first image IM1 transmits through the transmission area TA of the second pixel area PXA(s, k) of the second display part DPP2.

When the display panel DP is in the bent shape, the display device may display the image according to the user's needs. In such an embodiment, the portability of the display device may be improved when the display panel is in the bent shape.

Referring to FIGS. 7A and 7B, when the display panel is in the second mode, the second display surface DPS2 is defined on the upper surface US of the display panel DP corresponding to the first display part DPP1 and the second display part DPP2. The first image IM1 and a second image IM2 are displayed on the second display surface DPS2. The first image IM1 is generated by the first display part DPP1, and the second image IM2 is generated by the second display part DPP2.

In one exemplary embodiment, for example, the first image IM1 may include the image of watch and the second image IM2 may include a plurality of icon images, as shown in FIG. 7A. The first display part DPP1 may display a same image even though the operation mode of the display device is changed.

In an exemplary embodiment, the first display part DPP1 may generate a third image (not shown) including information different from information of the first image IM1. The third image may provide different image information from the second image IM2. In one exemplary embodiment, for example, the third image may provide calendar information. When the operation mode of the display device is changed to the second mode from the first mode, images displayed on the second display surface DPS2 at an earlier stage may be changed by the setting of the display device.

The second image IM2 and the third image may be different portions of the image related to one image information, that is, may collectively define a single image. In an exemplary embodiment, the second image IM2 and the third image may be different portions an enlarged image of the first image IM1 displayed in the first mode. In one exemplary embodiment, for example, when the first image IM1 represents the whole body of human being in the first mode, the second image IM2 may represent the lower half of the body of the human being in the second mode and the third image may represent the upper half of the body of the human being in the second mode. The display device may display an enlarged image that provides the same image information even though the operation mode thereof is changed.

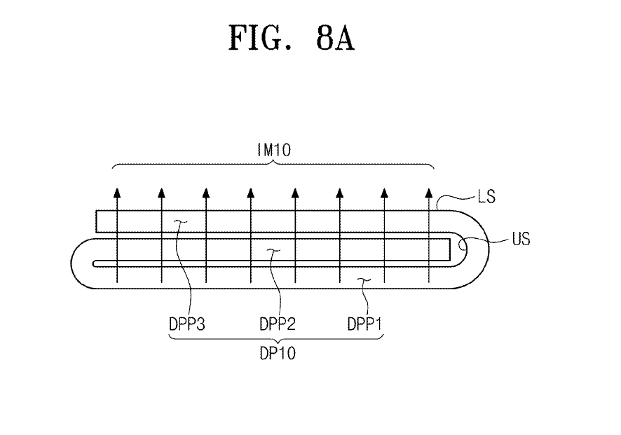

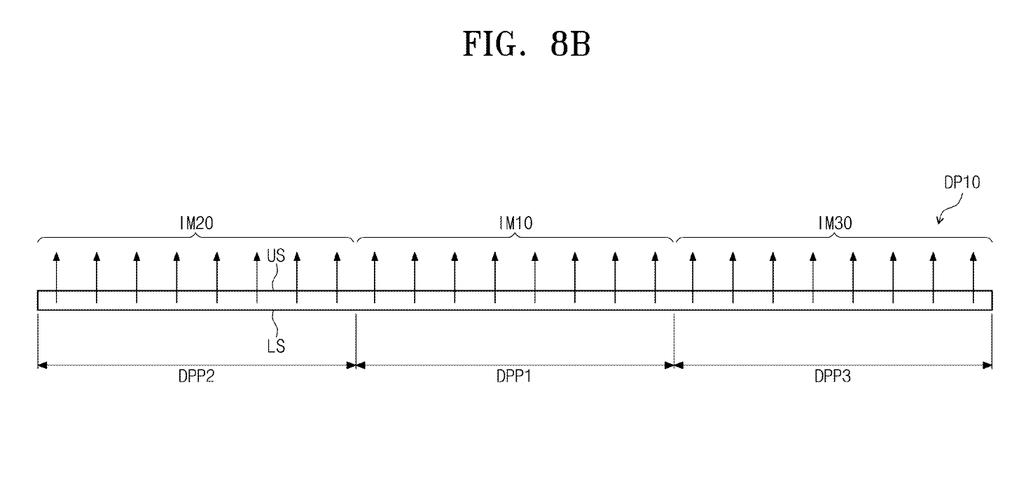

FIG. 8A is a side view showing an alternative exemplary embodiment of a flexible display panel in a bent shape, according to the invention, and FIG. 8B is a side view showing an alternative exemplary embodiment of a flexible display panel in an unbent shape, according to the invention. In FIGS. 8A and 8B, the same reference numerals denote the same elements in FIGS. 1A to 7B, and any repetitive detailed descriptions thereof will hereinafter be omitted.

Referring to FIGS. 8A and 8B, an exemplary embodiment of the display device includes a display panel DP10. The display device may include a first touch panel, a second touch panel, a sensor and a body part, which are not shown.

In an exemplary embodiment, the display panel DP10 may include a first display part DPP1, a second display part DPP2 and a third display part DPP3. In such an embodiment, the display panel DP10 further includes the third display part DPP3 compared to the exemplary embodiments of the display panel DP shown in FIGS. 1A to 1C.

When the display panel DP10 is stretched out or in the unbent shape, the second display part DPP2 is connected to one end of the first display part DPP1 and the third display part DPP3 is connected to the other end of the first display part DPP1, which is opposite to the one end. The display panel DP10 may be bent at a boundary area between the first display part DPP1 and the second display part DPP2 and at a boundary area between the first display part DPP1 and the third display part DPP3.

When the display panel DP 10 is in a bent shape, the second display part DPP2 and the third display part DPP3 are disposed to overlap the first display part DPP1. The second display part DPP2 is disposed between the third display part DPP3 and the first display part DPP1.

When the display panel DP10 is in the bent shape, the first display part DPP1 operates in the display mode, and the second and third display parts DPP2 and DPP3 operate in the transmission mode. When the display panel DP10 is in the unbent shape the first display part DPP1, the second display part DPP2 and the third display part DPP3 operate in the display mode.

As shown in FIG. 8A, a first image IM10 is displayed on the display surface in the first mode. The first image IM10 is generated by the first display part DPP1. The first image IM10 transmits through the second display part DPP2 and the third display part DPP3. The third display part DPP3 includes pixels each having the same structure as the second pixel PX(s, k) (refer to FIG. 5B) of the second display part DPP2.

In an exemplary embodiment, as shown in FIG. 8B, the first image IM10, a second image IM20 and a third image IM30 are displayed on the display surface in the second mode. The first image IM10, the second image IM20 and the third image IM30 may provide information independent of each other. The first, second and third images IM10, IM20 and IM30 may be different portions of the image related to one image information or a single image.

In an exemplary embodiment, the display panel may further include another display part connected to the first display part DDP1. In an exemplary embodiment, the display panel may further include another display part connected to the second display part DPP2 or the third display part DPP3.

Although exemplary embodiments of the invention have been described herein, it is understood that the invention should not be limited to these exemplary embodiments but various changes and modifications can be made by one ordinary skilled in the art within the spirit and scope of the present invention as hereinafter claimed.

What is claimed is:

1. A flexible display device comprising:
a flexible display panel which operates based on an operation mode thereof, which is selected by a shape thereof,
wherein the flexible display panel comprises:
a first display part; and
a second display part connected to the first display part,
wherein
the second display part operates in a transmission mode to transmit a first image displayed in the first display part when the flexible display panel is in a bent shape in which the second display part is disposed to overlap the first display part, and
the second display part operates in a display mode to display a second image when the flexible display panel is in an unbent shape, in which the second display part does not overlap the first display part.

2. The flexible display device of claim 1, wherein the first display part displays a third image different from the second image when the flexible display panel is in the unbent shape.

3. The flexible display device of claim 2, wherein the second image and the third image provide information independent of each other.

4. The flexible display device of claim 2, wherein the second image and the third image correspond to different portions of a single image.

5. The flexible display device of claim 1, wherein flexible display panel further comprises:
a third display part connected to the first display part,
wherein
the third display part operates in the transmission mode to transmit the first image when the flexible display panel is in the bent shape in which the third display part is disposed to overlap the first display part, and
the third display part operates in the display mode to display a third image when the flexible display panel is in the unbent shape, in which the third display part does not overlap the first display part.

6. The flexible display device of claim 5, wherein
when the flexible display panel is in the unbent shape, in which the first display part, the second display part and the third display part do not overlap each other, the second display part is connected to one end of the first display part and the third display part is connected to the other end of the first display part, which is opposite to the one end.

7. The flexible display device of claim 6, wherein,
when the flexible display panel is in the unbent shape, in which the first display part, the second display part and the third display part do not overlap each other, the first display part displays a fourth image different from the second image and the third image.

8. The flexible display device of claim 7, wherein the second image, the third image and the fourth image provide information independent of each other.

9. The flexible display device of claim 7, wherein the second image, the third image and the fourth image correspond to different portions of a single image.

10. The flexible display device of claim 1, further comprising:
a sensor which senses deformation in the shape of the flexible display panel.

11. The flexible display device of claim 10, wherein the sensor comprises a stress sensor disposed in a boundary between the first display part and the second display part.

12. The flexible display device of claim 10, wherein the sensor comprises a gravity sensor disposed in the second display part.

13. The flexible display device of claim 1, further comprising:
a first touch panel disposed on a lower surface of the flexible display panel; and
a second touch panel disposed on an upper surface of the flexible display panel,
wherein
the first touch panel is disposed to overlap the second display part, and
the second touch panel is disposed to overlap the first display part.

14. The flexible display device of claim 13, wherein the second touch panel is disposed to overlap the second display part.

15. The flexible display device of claim 14, further comprising:
a body part coupled to the lower surface of the flexible display panel corresponding to the first display part.

16. The flexible display device of claim 1, wherein
the flexible display panel comprises a base substrate comprising a plurality of pixel areas, and signal lines disposed on the base substrate,
the first display part comprises a plurality of first pixels respectively disposed in first pixel areas among the pixel areas,
the second display part comprises a plurality of second pixels respectively disposed in second pixel areas among the pixel areas, and
each of the second pixel areas comprises a transmission area and a display area.

17. The flexible display device of claim 16, wherein
each of the first pixels comprises:
a first circuit part connected to a corresponding signal line of the signal lines; and
a first display device connected to the first circuit part, and
each of the second pixels comprises:
a second circuit part connected to a corresponding signal line of the signal lines; and
a second display device connected to the second circuit part.

18. The flexible display device of claim 17, wherein
the first display device comprises an organic light emitting diode, and
the organic light emitting diode comprises an electrode having a same area as an area of a corresponding first pixel area of the first pixel areas.

19. The flexible display device of claim 17, wherein
the second display device comprises an organic light emitting diode, and
the organic light emitting diode comprises an electrode which overlaps the display area and exposes the transmission area.
